(19) United States
(12) Patent Application Publication
(10) Pub. No.: US 2026/0112770 A1
(43) Pub. Date: Apr. 23, 2026

(54) SELECTIVELY GAS PERMEABLE VENT FOR A BATTERY CELL

(71) Applicant: GM GLOBAL TECHNOLOGY OPERATIONS LLC, Detroit, MI (US)

(72) Inventors: Nathaniel HARDIN, Farmington Hills, MI (US); Matthew Arthur CELENTANO, Berkley, MI (US); Adam CROWE, Chesterfield, MI (US); Reza KAVIAN, Sterling Heights, MI (US); Young Nam KIM, Troy, MI (US)

(21) Appl. No.: 18/918,170

(22) Filed: Oct. 17, 2024

(51) Int. Cl. H01M 50/30; H01M 50/358

(52) U.S. Cl. CPC H01M 50/394; H01M 50/358

(57) ABSTRACT

A battery cell includes an enclosure including a plurality of walls that define a cell stack receiving zone, a one-way valve mounted to the enclosure on one of the plurality of walls and fluidically connected to the cell stack receiving zone. The one-way valve includes an inlet mounted to the one of the plurality of walls, an outlet, and a valve member that selectively connects the inlet and the outlet to vent the cell stack receiving zone. A gas permeable membrane is arranged between the cell stack receiving zone of the enclosure and the outlet of the one-way valve. The gas permeable membrane allows selected gases to flow from the cell stack receiving zone through the outlet while preventing substances from passing through the outlet into the cell stack receiving zone.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of battery assemblies and, more particularly, to a battery assembly including battery cell can having a selectively permeable vent.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cell enclosures or “cans” include cathode electrodes, anode electrodes, and separators arranged in a battery cell stack. The cathode electrodes include a cathode active material layer arranged on a cathode current collector. The anode electrodes include an anode active material layer arranged on an anode current collector. The cathode electrode and the anode electrode are connected to cathode and anode terminals arranged on an outer surface of the cell can.

Battery modules are formed from multiple cell cans arranged in a housing. The anode and cathode terminals of the battery cells are connected to provide a desired output voltage. Each cell can includes a vent that is designed to open if pressure within the can exceeds a predetermined value.

### SUMMARY

A battery cell, in accordance with the present disclosure, includes an enclosure including a plurality of walls that define a cell stack receiving zone, a one-way valve mounted to the enclosure on one of the plurality of walls and fluidically connected to the cell stack receiving zone. The one-way valve includes an inlet mounted to the one of the plurality of walls, an outlet, and a valve member that selectively connects the inlet and the outlet to vent the cell stack receiving zone. A gas permeable membrane is arranged between the cell stack receiving zone of the enclosure and the outlet of the one-way valve. The gas permeable membrane allows selected gases to flow from the cell stack receiving zone through the outlet while preventing substances from passing through the outlet into the cell stack receiving zone.

In other features, the one-way valve includes a valve seat and a check ball selectively arranged on the valve seat, the gas permeable membrane being arranged at the inlet of the one-way valve.

In other features, the one-way valve includes a flapper pivotally mounted to one of the plurality of walls forming the enclosure.

In other features, the gas permeable membrane includes a water absorbing material.

In other features, the gas permeable membrane is formed from a gas permeable material encapsulating the water absorbing material.

In other features, the gas permeable membrane is formed from a plurality of layers including a first layer formed from a first gas permeable material and a second layer formed from a water absorbing material.

In other features, the plurality of layers includes a third layer formed from a second gas permeable material, the second layer formed from the water absorbing material being sandwiched between the first layer and the third layer.

In other features, the first gas permeable material is a first hydrophobic gas permeable polymer, and the second gas permeable material is a second hydrophobic gas permeable polymer.

In other features, the water absorbing material includes a plurality of ceramic particles.

In other features, the plurality of ceramic particles defines a three-angstrom (3A) molecular sieve.

In other features, the gas permeable membrane is formed from a plurality of layers including a first layer formed from a gas permeable material and a second layer formed from a hydrophobic material.

In other features, the second gas permeable hydrophobic polymer forming the second layer is a superhydrophobic gas permeable polymer.

In other features, the gas permeable membrane includes a hydrophobic coating.

In other features, the hydrophobic coating is formed from a superhydrophobic material.

In other features, the gas permeable membrane includes a debris catching porous material.

In other features, the gas permeable membrane includes a gas permeability coefficient of between about 280 and about 4100.

In other features, the one-way valve comprises a gas permeable membrane member.

A method of venting a battery cell, in accordance with the present disclosure includes providing an initial formation charge to a battery stack in an enclosure, venting gases produced by the battery stack during the initial formation charge through a gas permeable membrane supported by the enclosure, providing a second formation charge to the battery stack in the enclosure, and venting gases produced by the battery stack during the second formation charge through the gas permeable membrane supported by the enclosure.

In other features, passing the gases through the gas permeable membrane includes passing the gases through a gas permeable hydrophobic material.

In other features, passing the gases through the gas permeable membrane further includes passing the gases through a water absorbent material.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a front view of a prismatic cell can including a vent having a selectively permeable hydrophobic vent membrane, in accordance with an aspect of the present disclosure;

FIG. 2 is a front view of a prismatic cell can including a vent having a selectively permeable hydrophobic vent membrane, in accordance with another aspect of the present disclosure;

FIG. 3 is a front view of a prismatic cell can including a vent having a selectively permeable hydrophobic vent membrane, in accordance with yet another aspect of the present disclosure;

FIG. 4 depicts cross-sectional view of a selectively permeable hydrophobic vent membrane having encapsulated moisture absorbing particles, in accordance with an aspect of the present disclosure;

FIG. 5 6 depicts cross-sectional view of a selectively permeable hydrophobic vent membrane having a moisture absorbing layer sandwiched between first and second hydrophobic layers, in accordance with an aspect of the present disclosure;

FIG. 6 depicts cross-sectional view of a selectively permeable hydrophobic vent membrane having a superhydrophobic coating, in accordance with an aspect of the present disclosure;

FIG. 7 depicts a cross-sectional view of a selectively permeable hydrophobic vent membrane having a particle trap layer, in accordance with an aspect of the present disclosure.

In the drawings, reference numbers may be reused to identify similar and/or identical elements.

### DETAILED DESCRIPTION

The size and shape of enclosures can vary. Prismatic enclosures include a length distance, a width distance, and a height distance and may be formed as tall enclosures or long enclosures. For a tall enclosure, the height distance is greater than each of the width distance and the length distance. For long enclosures, the length distance is greater than each of the height distance and the width distance. The terminals for tall cells are typically arranged on an upper surface while the terminals for long cells may be arranged on upper or end surfaces.

Prismatic can battery cells typically include a vent cap. During a thermal runaway event, the vent cap bursts to allow at least one of vent gases and ejecta that may develop during thermal runaway to exit the enclosure. Given the construction of the tall cells, the vent caps are typically arranged on the upper surface or on the lower surface. Arrangement on the upper or the lower surface provides room for cooling systems that engage side surfaces of the prismatic can battery cell.

In addition to venting gases generated by a thermal runaway, battery enclosures are vented during initial formation or charging. When charging, particularly during an initial, a second and/or subsequent charges, battery cells produce gas. For at least the initial charge, gas is vented through a removeable plug. During subsequent charging, gas slowly dissipates from the cell. Including a gas permeable vent would reduce manufacturing steps by allowing venting during initial cell formation and would also improve charging efficiency by allowing gas to escape from the cell during charging cycles.

A battery cell, in accordance with the present disclosure, is indicated generally at 10 in FIG. 1. Battery cell 10 includes an enclosure 12 formed from a plurality of walls 14. Plurality of walls 14 include a base wall 16, a top wall 18, a first side wall 20, and a second side wall 22. Base wall 16, top wall 18, first side wall 20, second side wall 22, and additional walls (not shown) collectively form a battery stack receiving zone 28. A battery stack 32 is arranged in Battery stack receiving zone 28. Battery stack 32 is connected to a first terminal 34 and a second terminal 36 shown supported on top wall 18. The location of first and second terminals may vary. While shown as a prismatic can, enclosure 12 may take on various forms.

In accordance with the present disclosure, enclosure 12 includes a vent 40 that facilitates passage of gases from battery stack receiving zone 28 to ambient or to a surrounding environment. In accordance with one exemplary aspect, vent 40 includes a one-way valve 42 and a gas permeable membrane 44. Gas permeable membrane 44 is formed from a material selected to permit selected gases, such as carbon dioxide and selected alkanes/alkenes to pass from battery stack receiving zone 28. Gas permeable membrane 44 may be secured to enclosure 12 through a variety of techniques including the use of adhesives, sandwiching between plates and gaskets, and crimping. While shown on top wall 18, vent 40 may be arranged on any one of the plurality of walls 14 depending on battery requirements. In one non-limiting example, gas permeable membrane 44 includes a gas permeability coefficient of between about 280 and about 4100.

One-way valve 42 includes an inlet 46 fluidically connected to battery stack receiving zone 28, an outlet 48, and a valve member 50. Valve member 50 facilitates gas flow from inlet 46 to outlet 48 while preventing flow in a reverse direction. Gas permeable membrane 44 is arranged at inlet 46 of one-way valve 42. In this manner, one-way valve 42 permits outgassing of gases from battery stack receiving zone 28 that may develop during charging and/or discharging cycles of battery cell 10.

In accordance with a non-limiting example, one-way valve 42 may include a flapper 52 pivotally mounted to enclosure 12 through a hinge 54. Gases passing from Battery stack receiving zone 28 into inlet 46, pass from outlet 48 and unseat flapper 52. The gases may then pass to ambient. In addition to facilitating outgassing of gases from Battery stack receiving zone 28, gas permeable membrane 44 excludes selected materials from passing into battery stack receiving zone 28. For example, gas permeable membrane 44 may be formed from a gas permeable hydrophobic material 60 that allows select gases to pass outward yet prevents moisture from entering battery stack receiving zone 28.

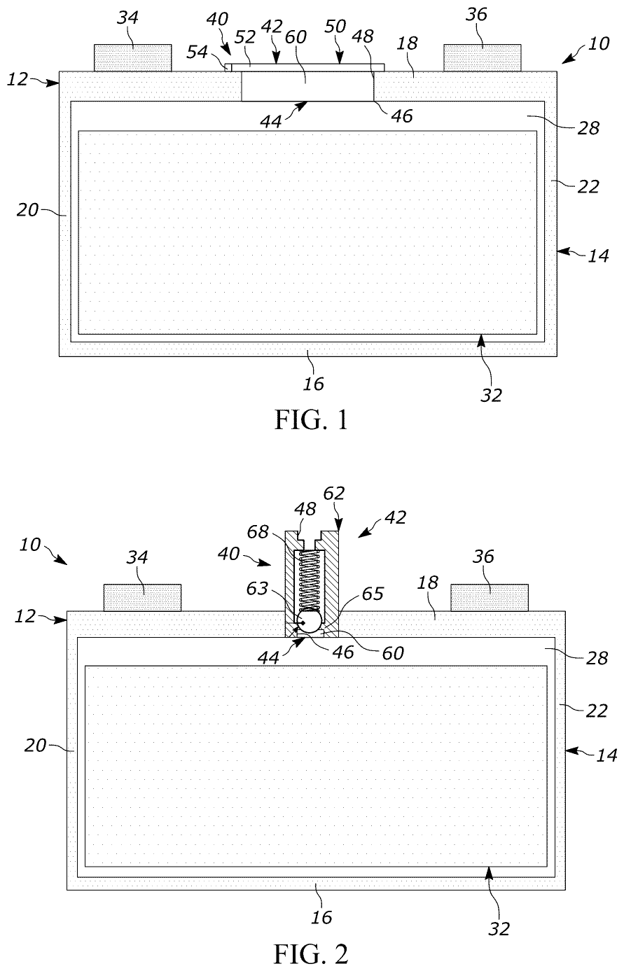

One-way valve 42 may take on various forms. For example, one-way valve 42 may take the form of a ball valve 62 such as shown in FIG. 2. Ball valve 62 includes a check ball 63 that is biased against a valve seat 65 by a spring 68. Spring 68 is designed to allow check ball 63 to unseat from valve seat 65 when exposed to selected pressures. The selected pressure may be chosen to ensure a positive flow through one-way valve 42 so as to minimize any return flow or exposure of battery stack receiving zone 28 to ambient.

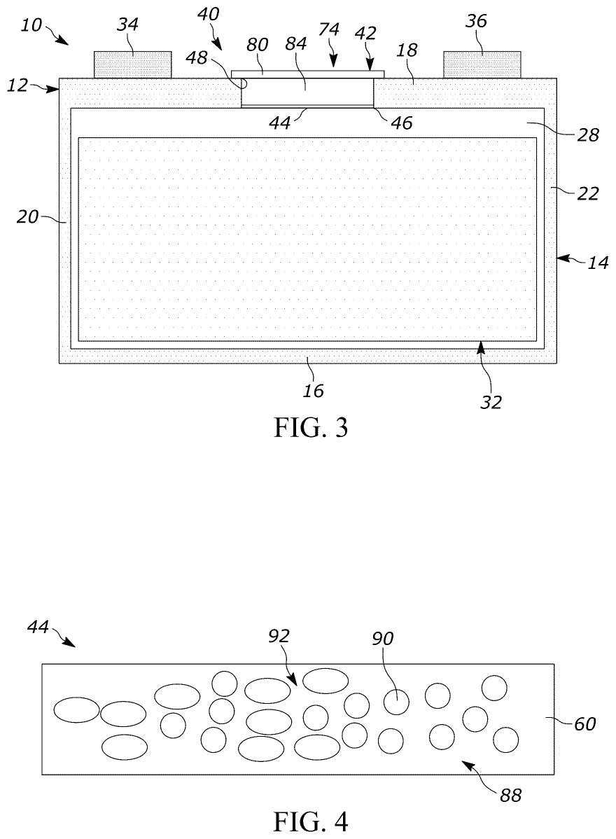

One-way valve 42 may also take the form of a dual membrane valve 74 such as shown in FIG. 3. Dual membrane valve 74 includes another gas permeable membrane 80 positioned across outlet 48. With this arrangement, gases produced in battery stack receiving zone 28 may first pass through gas permeable membrane 44 into a void 84 formed in top wall 18 between inlet 46 and outlet 48. Depending on the pressure of gases in void 84, flow may proceed through another gas permeable membrane 80 to ambient. If the pressure in void 84 exceeds a selected pressure value, another gas permeable membrane 80 may be unseated to allow accumulating gases to pass to ambient.

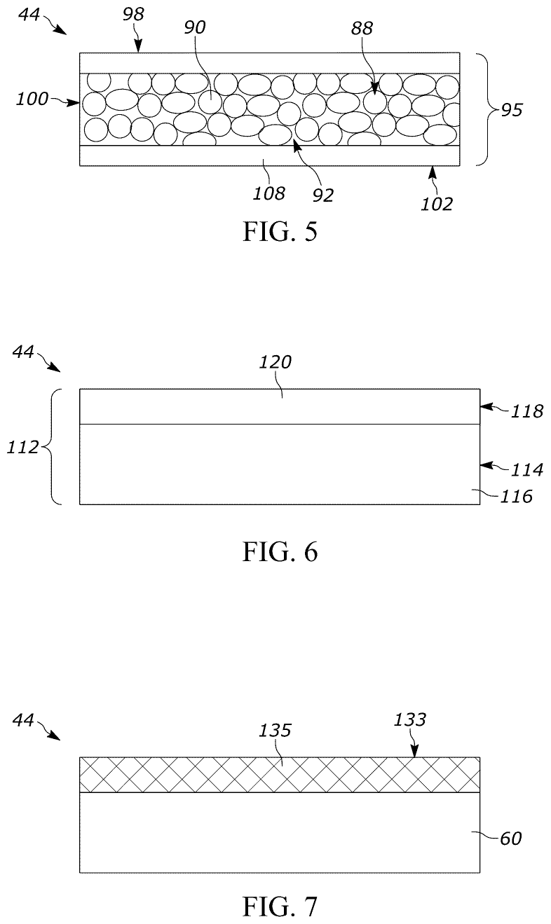

Gas permeable membrane 44 may take on various forms. For example, as shown in FIG. 4, gas permeable hydrophobic material 60 may encapsulate an amount of water absorbing material 88 (e.g., desiccant). Water absorbing material 88 may take the form of ceramic particles 90 that define a three angstrom (3A) molecular sieve 92. Of course, other materials may be used to absorb water. In addition to absorbing any water that might make its towards battery stack receiving zone 28, water absorbent material 88 may enhance the structural stability of gas permeable membrane 44. Gas permeable membrane 44 may, in the alternative, be formed from a plurality of layers 95 such as shown in FIG. 5. Plurality of layers 95 is shown to include a first layer 98, a second layer 100, and a third layer 102. First layer 98 and third layer 102 are formed from a gas permeably hydrophobic material while third layer 102 is formed from water absorbing material 88.

FIG. 6 depicts gas permeable membrane 44 formed from a plurality of layers 112 including a first layer 114 formed from gas permeable material 116 and a second layer 118 formed from a hydrophobic material 120. Second layer 118 may be a separate layer joined to first layer 114 or may take the form of a hydrophobic coating formed from hydrophobic material or super hydrophobic material. At this point, it should be understood that the term hydrophobic material defines a material having a water contact angle of more than 90-degrees. Super hydrophobic material describes a material having a water contact angle of greater than 150-degress and a sliding angle of 5-degrees.

Gas permeable membrane 44 may also include a particle trap layer 133 such as shown in FIG. 7. Particle trap layer 133 is formed from a debris catching material mesh 135 that prevents foreign objects from entering battery stack receiving zone 28 when gas is passing through one-way valve 42. Thus, vent 40 provides a pathway for gases generated by battery stack 32 to pass outward from battery cell 10 to alleviate pressures within battery stack receiving zone 28. Alleviating internal pressures in a battery call can enhance battery cell performance and longevity. In addition to allowing gases to exit, vent 40 also prevents unwanted substances from entering during an outgassing cycle which could contaminate internal battery cell components.

Vent 40 also provides advantages during battery cell manufacture. Previously, after manufacture, a temporary plug was installed in a battery cell enclosure. The temporary plug was then removed during an initial formation charge of the battery cell allowing gases to escape. When the temporary plug is removed, battery stack receiving zone is exposed to the environment. After purging any gases developed during initial formation, a permanent plug is installed, and a closure plate is welded into place before the battery cell undergoes a second formation charge. The vent described in accordance with the present disclosure eliminates the need for a temporary plug and associated actions needed to remove the plug and seal the battery cell enclosure after degassing.

In accordance with the present disclosure, gases generated during the first formation may pass through gas permeable membrane 44 and out from battery stack receiving zone 28 via one-way valve 42. Gases from a second formation change may likewise pass directly through gas permeable membrane 44 and out from battery stack receiving zone 28 via one-way valve 42. By eliminating the need for the temporary plug not only are battery manufacturing costs reduced, but battery cell efficiency is increased by providing gases with an escape route. Further, the presence of gas permeable membrane 44 eliminates battery stack receiving zone being exposed to potential environmental contaminants.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

When an element such as a layer, film, region, or substrate is referred to as being “on” another element, it can be directly on the other element or intervening elements may also be present. In contrast, when an element is referred to as being “directly on” another element, there are no intervening elements present.

The terms “about” and “substantially” are intended to include the degree of error associated with measurement of the particular quantity based upon the equipment available at the time of filing the application. For example, “about” and “substantially” can include a range of ±8% of a given value.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is

1. A battery cell comprising:
an enclosure including a plurality of walls that define a cell stack receiving zone;
a one-way valve mounted to the enclosure on one of the plurality of walls and fluidically connected to the cell stack receiving zone, the one-way valve including an inlet mounted to the one of the plurality of walls, an outlet, and a valve member that selectively connects the inlet and the outlet to vent the cell stack receiving zone; and
a gas permeable membrane arranged between the cell stack receiving zone of the enclosure and the outlet of the one-way valve, the gas permeable membrane allowing selected gases to flow from the cell stack receiving zone through the outlet while preventing substances from passing through the outlet into the cell stack receiving zone.

2. The battery cell according to claim 1, wherein the one-way valve includes a valve seat and a check ball selectively arranged on the valve seat, the gas permeable membrane being arranged at the inlet of the one-way valve.

3. The battery cell according to claim 1, wherein the one-way valve includes a flapper pivotally mounted to one of the plurality of walls forming the enclosure.

4. The battery cell according to claim 1, wherein the gas permeable membrane includes a water absorbing material.

5. The battery cell according to claim 4, wherein the gas permeable membrane is formed from a gas permeable material encapsulating the water absorbing material.

6. The battery cell according to claim 4, wherein the gas permeable membrane is formed from a plurality of layers including a first layer formed from a first gas permeable material and a second layer formed from a water absorbing material.

7. The battery cell according to claim 6, wherein the plurality of layers includes a third layer formed from a second gas permeable material, the second layer formed from the water absorbing material being sandwiched between the first layer and the third layer.

8. The battery cell according to claim 7, wherein the first gas permeable material is a first hydrophobic gas permeable polymer, and the second gas permeable material is a second hydrophobic gas permeable polymer.

9. The battery cell according to claim 4, wherein the water absorbing material includes a plurality of ceramic particles.

10. The battery cell according to claim 9, wherein the plurality of ceramic particles defines a three-angstrom (3A) molecular sieve.

11. The battery cell according to claim 1, wherein the gas permeable membrane is formed from a plurality of layers including a first layer formed from a gas permeable material and a second layer formed from a hydrophobic material.

12. The battery cell according to claim 8, wherein the second gas permeable hydrophobic polymer forming the second layer is a superhydrophobic gas permeable polymer.

13. The battery cell according to claim 1, wherein the gas permeable membrane includes a hydrophobic coating.

14. The battery cell according to claim 13, wherein the hydrophobic coating is formed from a superhydrophobic material.

15. The battery cell according to claim 1, wherein the gas permeable membrane includes a debris catching porous material.

16. The battery cell according to claim 1, wherein the gas permeable membrane includes a gas permeability coefficient of between about 280 and about 4100.

17. The battery cell according to claim 1, wherein the one-way valve comprises a gas permeable membrane member.

18. A method of venting a battery cell comprising:
providing an initial formation charge to a battery stack in an enclosure;
venting gases produced by the battery stack during the initial formation charge through a gas permeable membrane supported by the enclosure;
providing a second formation charge to the battery stack in the enclosure; and
venting gases produced by the battery stack during the second formation charge through the gas permeable membrane supported by the enclosure.

19. The method of claim 18, wherein passing the gases through the gas permeable membrane includes passing the gases through a gas permeable hydrophobic material.

20. The method of claim 18, wherein passing the gases through the gas permeable membrane further includes passing the gases through a water absorbent material.
